(19) United States
(12) Patent Application Publication
(10) Pub. No.: US 2023/0261415 A1
(43) Pub. Date: Aug. 17, 2023

(54) CONNECTOR

(71) Applicant: Japan Aviation Electronics Industry, Limited, Tokyo (JP)

(72) Inventor: Kenta ASHIBU, Tokyo (JP)

(21) Appl. No.: 18/149,626

(22) Filed: Jan. 3, 2023

(30) Foreign Application Priority Data
Feb. 14, 2022 (JP) 2022020351

(51) Int. Cl. H01R 13/58

(52) U.S. Cl. CPC H01R 13/5808; H01R 2201/12

(57) ABSTRACT

A connecter includes a conductive contact connected to the connection object and including a tubular portion and a top plate portion of annular shape joined to one end of the tubular portion, the top plate portion having a through hole, and a housing including a first surface facing the top surface of the sheet-like conductive member and a contact accommodating portion of recess shape formed in the first surface and accommodating the tubular portion of the contact, the housing including a projection formed to project in the contact accommodating portion from a bottom surface of the contact accommodating portion and penetrating the through hole of the tubular portion accommodated in the contact accommodating portion and a deformed portion overhanging in a direction along the first surface from a tip of the projection in the tubular portion and covering the top plate portion around the through hole.

### BACKGROUND OF THE INVENTION

The present invention relates to a connector, particularly to a connector in which a conductive connection object is connected to a flexible conductor of a sheet-like conductive member.

In recent years, attention has been drawn to so-called smart clothes that can obtain user's biological data such as the heart rate and the body temperature only by being worn by the user. Such smart clothes are equipped with an electrode disposed at a measurement position and formed of a flexible conductor, and when a wearable device serving as a measurement device is electrically connected to the electrode, it is possible to send biological data to the wearable device.

Connection between the electrode and the wearable device can be established by using, for example, a connector to be connected to the flexible conductor.

As a connector of this type, for example, JP 2018-129244 A discloses a connector shown in FIG. 8. This connector includes a housing 2 and a base member 3 that are separately disposed on opposite sides across a flexible substrate 1 to sandwich the flexible substrate 1. A tubular portion 4A of a contact 4 is passed through a contact through-hole 2A of the housing 2, and a flange 4B of the contact 4 is sandwiched between the housing 2 and a flexible conductor 1A exposed on a surface of the flexible substrate 1.

In this state, by pushing the base member 3 toward the housing 2, as shown in FIG. 9, a projection 3A of the base member 3 is inserted into a projection accommodating portion 4C of the contact 4 with the flexible substrate 1 being sandwiched therebetween, and an inner surface of the projection accommodating portion 4C makes contact with the flexible conductor 1A with a predetermined contact force, whereby the contact 4 is electrically connected to the flexible conductor 1A.

In addition, as shown in FIG. 8, the housing 2 and the base member 3 are fixed to each other by press-fitting a housing fixing post 3B, which is formed to project on the base member 3, into a post accommodating portion 2B of the housing 2.

When a wearable device is fitted with the connector disclosed in JP 2018-129244 A, the wearable device can be connected to an electrode formed of a flexible conductor.

However, in the case where the wearable device is disposed apart from a measurement position, it is necessary to constitute an electrical path from the electrode disposed at the measurement position to an attachment position of the connector, and when such an electrical path is formed of the flexible conductor, electric resistance becomes high, and cost increases.

To cope with it, in order to connect an electrode formed of a flexible conductor to a wearable device by an inexpensive electric wire with low electric resistance, the development of a small-sized connector for connecting a connection object such as an electric wire to a flexible conductor disposed on a garment is desired.

As a connector of this type, by using a connector having such a configuration that a projection of a base member is inserted into a projection accommodating portion of a contact with a flexible conductor being sandwiched therebetween like the connector disclosed in JP 2018-129244 A, a connection object such as an electric wire is connected to the contact, whereby the flexible conductor and the connection object are electrically connected to each other.

However, in the connector of JP 2018-129244 A, since the contact 4 is present, the post accommodating portion 2B and the housing fixing post 3B that are for fixing the housing 2 and the base member 3 to each other need to be separately disposed at positions away from the contact 4, and thus it is difficult to reduce a size of the connector.

### SUMMARY OF THE INVENTION

The present invention has been made to solve the conventional problem described above and aims at providing a connector capable of reducing the size thereof while a conductive connection object is connected to a flexible conductor of a sheet-like conductive member.

A connector according to the present invention is one in which a connection object having conductivity is connected to a flexible conductor exposed at least on a bottom surface of a sheet-like conductive member having a top surface and the bottom surface facing in opposite directions from each other, the connector comprising:

a contact having conductivity, being connected to the connection object, and including a tubular portion and a top plate portion of annular shape joined to one end of the tubular portion and provided with a through hole; and

a housing including a first surface facing the top surface of the sheet-like conductive member, and a contact accommodating portion of recess shape formed in the first surface and accommodating the tubular portion of the contact,

wherein the housing includes a projection formed to project in the contact accommodating portion from a bottom surface of the contact accommodating portion and penetrating the through hole of the top plate portion joined to the tubular portion accommodated in the contact accommodating portion, and a deformed portion overhanging in a direction along the first surface from a tip of the projection in the tubular portion and covering the top plate portion around the through hole, and

wherein the top plate portion of the contact is fixed to the housing by the deformed portion of the projection in a state where the first surface of the housing makes contact with the top surface of the sheet-like conductive member and the tubular portion of the contact is accommodated in the contact accommodating portion with the sheet-like conductive member being sandwiched therebetween, and an outer peripheral surface of the tubular portion makes contact with the flexible conductor of the sheet-like conductive member in a direction parallel to the first surface, whereby the connection object is electrically connected to the flexible conductor via the contact.

### BRIEF DESCRIPTION OF THE DRAWINGS

FIG. 1 is a perspective view showing a connector according to an embodiment when viewed from an obliquely upper position.

FIG. 2 is a perspective view showing the connector according to the embodiment when viewed from an obliquely lower position.

FIG. 3 is a plan view showing the connector according to the embodiment.

FIG. 4 is a cross-sectional view taken along line A-A in FIG. 3.

FIG. 5 is an enlarged view of an important part of FIG. 4.

FIG. 6 is a bottom view showing the connector according to the embodiment in the process of assembling.

FIG. 7 is a cross-sectional view taken along line B-B in FIG. 6.

FIG. 8 is an exploded perspective view showing a conventional connector.

FIG. 9 is a partial cross-sectional view showing the conventional connector.

### DETAILED DESCRIPTION OF THE INVENTION

An embodiment of the present invention is described below based on the appended drawings.

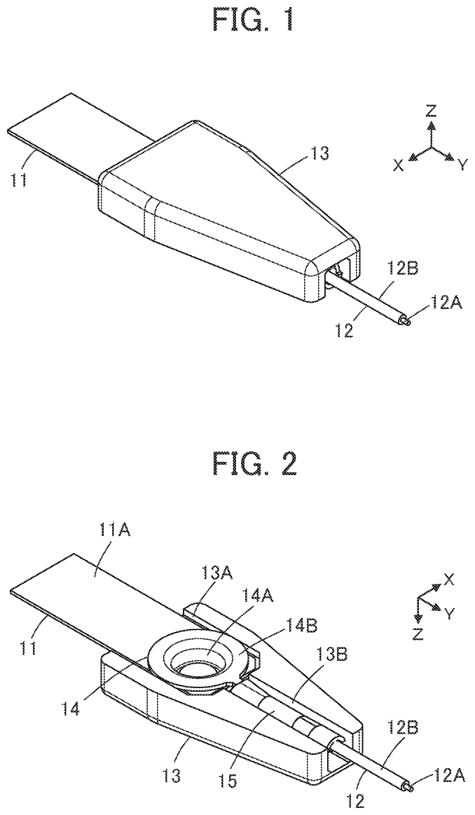

FIGS. 1 and 2 respectively show perspective views of a connector according to the embodiment when viewed from obliquely upper and lower positions. The connector is configured such that a covered electric wire 12 being a conductive connection object is connected to a sheet-like conductive member 11, and includes a housing 13 made of an insulating resin material, and a conductive contact 14 held by the housing 13.

The sheet-like conductive member 11 has a top surface and a bottom surface facing in opposite directions from each other and has a flexible conductor 11A exposed at least on the bottom surface. As the sheet-like conductive member 11, conductive cloth woven using a conductive thread such as silver can be used, for example. When such conductive cloth is used, the flexible conductor 11A is exposed not only on the bottom surface but also on the top surface of the sheet-like conductive member 11. In addition, one obtained by applying a conductive ink on a bottom surface of cloth having no conductivity by printing or another method to form the flexible conductor 11A on the bottom surface can also be used as the sheet-like conductive member 11. Further, a member obtained by forming the flexible conductor 11A formed of a conductive pattern on a bottom surface of an insulating sheet body such as a resin film may be used as the sheet-like conductive member 11.

The sheet-like conductive member 11 shown in FIGS. 1 and 2 has a band shape extending in a predetermined direction.

The covered electric wire 12 has such a structure that an outer periphery of a conductor portion 12A is covered with a covering portion 12B made of an insulating material. With the connector according to the embodiment, the conductor portion 12A of the covered electric wire 12 is electrically connected to the flexible conductor 11A of the sheet-like conductive member 11.

The covered electric wire 12 shown in FIGS. 1 and 2 extends in the same direction as the direction in which the sheet-like conductive member 11 of band shape extends.

The housing 13 has a flat plate shape extending in parallel to the sheet-like conductive member 11, and a bottom surface of the housing 13 is provided with a recessed portion 13A of rectangular shape and a linear groove 13B communicating with the recessed portion 13A. The sheet-like conductive member 11 and the covered electric wire 12 are connected to each other in the housing 13.

The contact 14 is accommodated in the recessed portion 13A of the housing 13 and includes a tubular portion 14A of cylindrical shape having a central axis extending in a direction perpendicular to the housing 13 of flat plate shape, and a flange 14B of annular shape joined to the tubular portion 14A.

In addition, a crimp terminal portion 15 integrally formed with the contact 14 is joined to the flange 14B of the contact 14 and accommodated in the groove 13B of the housing 13, and an end portion of the covered electric wire 12 is connected to the crimp terminal portion 15.

For convenience, the predetermined direction in which the sheet-like conductive member 11 extends toward the housing 13 is called “+Y direction,” the width direction of the sheet-like conductive member 11 of band shape “X direction,” and the direction orthogonal to an XY plane “Z direction.”

The sheet-like conductive member 11 and the housing 13 extend along an XY plane. The recessed portion 13A is situated on the −Y direction side on a surface, facing in the −Z direction, of the housing 13, and the groove 13B extends in the +Y direction from the recessed portion 13A. A +Y directional end portion of the sheet-like conductive member 11 is connected to the contact 14, and a −Y directional end portion of the covered electric wire 12 is connected to the contact 14 via the crimp terminal portion 15.

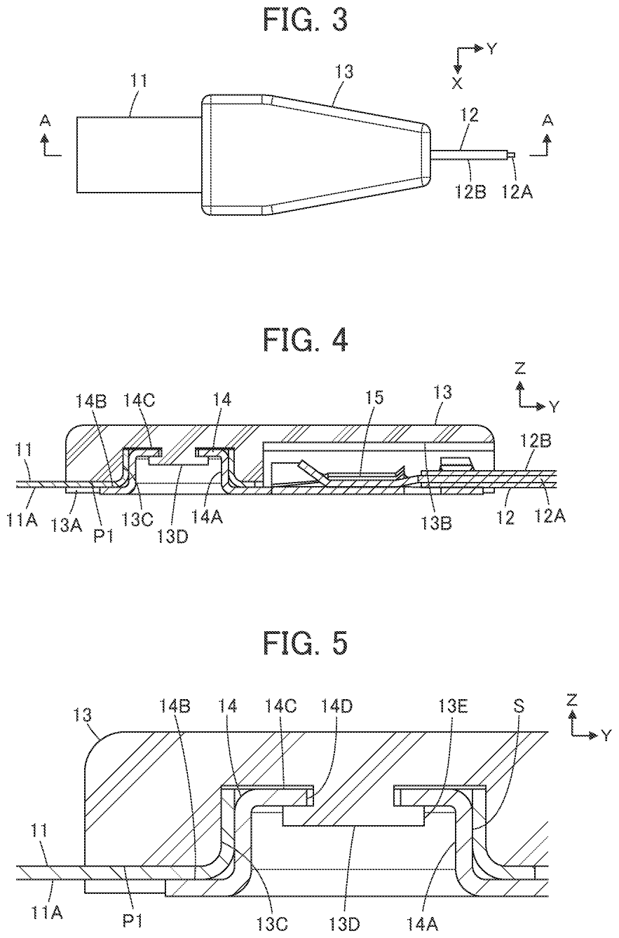

As shown in FIG. 3, the housing 13 has a flat shape apparently formed of a rectangular shape situated on the −Y direction side combined with a trapezoidal shape situated on the +Y direction side when viewed in the Z direction, and has an X directional width that is narrower at its +Y directional end portion than at its −Y directional end portion.

As shown in FIG. 4 that is a cross-sectional view taken along line A-A of FIG. 3, a bottom surface, facing in the −Z direction, of the recessed portion 13A of the housing 13 forms a first surface P1 facing a +Z directional surface of the sheet-like conductive member 11, and a contact accommodating portion 13C of recess shape recessed in the +Z direction is formed in the first surface P1.

The housing 13 further includes a projection 13D formed to project in the −Z direction from a bottom surface, facing in the −Z direction, of the contact accommodating portion 13C toward the interior of the contact accommodating portion 13C.

The tubular portion 14A of the contact 14 is accommodated in the contact accommodating portion 13C. The contact 14 includes a top plate portion 14C of annular shape joined to a +Z directional end portion of the tubular portion 14A. The top plate portion 14C extends from the +Z directional end portion of the tubular portion 14A toward the central axis of the tubular portion 14A along an XY plane, and faces the bottom surface of the contact accommodating portion 13C.

A cut-out portion (not shown) is formed near the +Y directional end portion of the sheet-like conductive member 11, and the tubular portion 14A of the contact 14 is accommodated in the contact accommodating portion 13C of the housing 13 while penetrating the cut-out portion of the sheet-like conductive member 11 from the −Z direction with the sheet-like conductive member 11 being sandwiched between the tubular portion 14A and the housing 13. Therefore, the sheet-like conductive member 11 is sandwiched between an inner peripheral surface of the contact accommodating portion 13C of the housing 13 and the tubular portion 14A of the contact 14.

Note that the flange 14B of annular shape of the contact 14 extends from a −Z directional end portion of the tubular portion 14A to the outside of the tubular portion 14A along an XY plane, and the crimp terminal portion 15 accommodated in the groove 13B of the housing 13 is joined to a +Y directional end portion of the flange 14B. In addition, the conductor portion 12A at the −Y directional end portion of the covered electric wire 12 is drawn from the covering portion 12B and crimped with the crimp terminal portion 15, and accordingly, the conductor portion 12A of the covered electric wire 12 is electrically connected to the contact 14.

As shown in FIG. 5 that is an enlarged partial view of FIG. 4, the top plate portion 14C of the contact 14 is provided with a through hole 14D through which the projection 13D of the housing 13 passes. A −Z directional end portion of the projection 13D is provided with a deformed portion 13E extending to the outside of the projection 13D along an XY plane.

The deformed portion 13E overhangs in a direction along an XY plane in the tubular portion 14A of the contact 14 and covers a surface, facing in the −Z direction, of the top plate portion 14C around the through hole 14D. Consequently, the top plate portion 14C of the contact 14 is pressed in the +Z direction by the deformed portion 13E to thereby be fixed with respect to the housing 13.

While the first surface P1 of the housing 13 makes contact with the top surface on the +Z direction side of the sheet-like conductive member 11, and the flexible conductor 11A is exposed at least on the bottom surface on the −Z direction side of the sheet-like conductive member 11, the sheet-like conductive member 11 is bent at a right angle at a position where the tubular portion 14A of the contact 14 is formed, and extends in the +Z direction while being sandwiched between an outer peripheral surface S of the tubular portion 14A and the inner peripheral surface of the contact accommodating portion 13C of the housing 13. Accordingly, the outer peripheral surface S of the tubular portion 14A of the contact 14 comes into contact with the flexible conductor 11A of the sheet-like conductive member 11 in a direction along an XY plane.

Here, the contact accommodating portion 13C of the housing 13 is formed in advance to have an inside diameter slightly smaller than a dimension obtained by adding a double of a thickness of the sheet-like conductive member 11 to an outside diameter of the tubular portion 14A of the contact 14; therefore, the flexible conductor 11A of the sheet-like conductive member 11 is pressed by the contact accommodating portion 13C against the outer peripheral surface S of the tubular portion 14A of the contact 14 such that a predetermined contact pressure is applied thereto, whereby the contact 14 is electrically connected to the flexible conductor 11A.

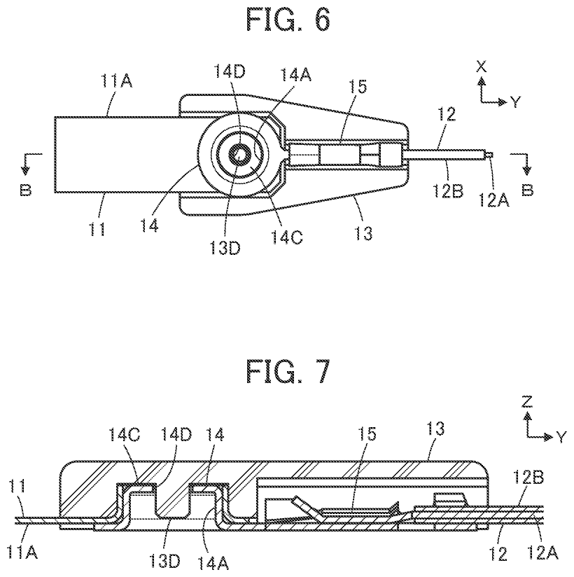

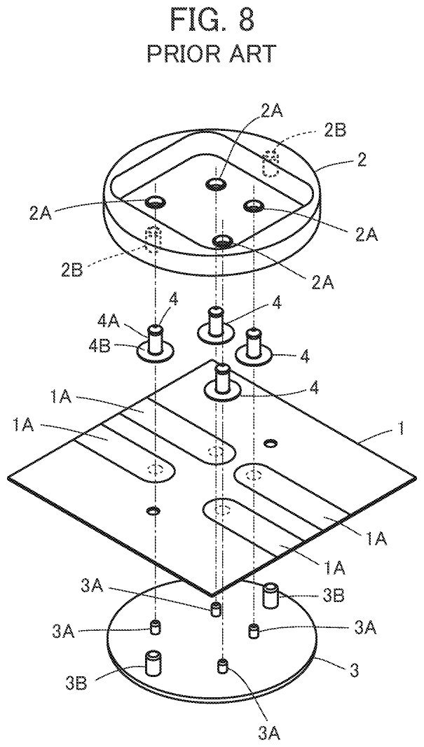

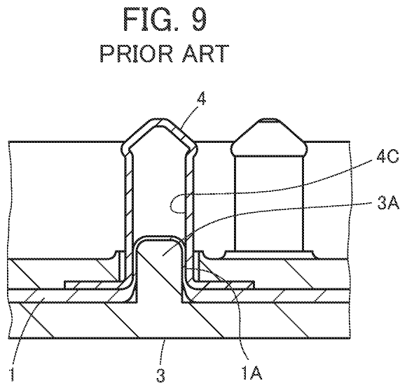

By inserting the tubular portion 14A of the contact 14 from the −Z direction into the contact accommodating portion 13C of the housing 13 with the sheet-like conductive member 11 being sandwiched therebetween when the deformed portion 13E is not formed at a tip of the projection 13D of the housing 13, the projection 13D is allowed to project in the −Z direction from the through hole 14D of the top plate portion 14C of the contact 14 as shown in FIGS. 6 and 7, and thereafter, the deformed portion 13E is formed in the tubular portion 14A of the contact 14 through heat deformation of the −Z directional end portion of the projection 13D, whereby the connector as above can be assembled.

Note that the conductor portion 12A at the −Y directional end portion of the covered electric wire 12 is drawn from the covering portion 12B and crimped with the crimp terminal portion 15 in advance, and accordingly, the conductor portion 12A of the covered electric wire 12 is electrically connected to the flexible conductor 11A of the sheet-like conductive member 11 via the contact 14 and the crimp terminal portion 15.

In the connector of the embodiment, the top plate portion 14C of the contact 14 is fixed with respect to the housing 13 by means of the deformed portion 13E situated at the −Z directional end portion of the projection 13D while the flexible conductor 11A of the sheet-like conductive member 11 and the contact 14 are electrically connected to each other using the contact accommodating portion 13C of the housing 13. Therefore, unlike the connector of JP 2018-129244 A, it is not necessary to dispose a fixing member at a position away from the contact, whereby the connector can be decreased in size.

In addition, since the deformed portion 13E that fixes the contact 14 with respect to the housing 13 is disposed inside the tubular portion 14A of the contact 14, particularly, a height size in the Z direction of the connector can be decreased, which makes it possible to obtain a thin connector.

When the connector of the embodiment is applied to smart clothes, and an electrode (not shown) is connected to the flexible conductor 11A of the sheet-like conductive member 11, the electrode disposed at a measurement position and a wearable device can be connected to each other by means of the inexpensive covered electric wire 12 with low electric resistance.

In the connector of the embodiment, the top plate portion 14C of the contact 14 is pressed in the +Z direction by the deformed portion 13E of the housing 13, whereby the flange 14B of the contact 14 can contact, with a predetermined contact pressure, the flexible conductor 11A of the sheet-like conductive member 11 being in contact with the first surface P1 of the housing 13. Therefore, the contact 14 is also electrically connected to the flexible conductor 11A via the flange 14B, whereby the reliability of electric connection between the contact 14 and the flexible conductor 11A can be improved.

In the embodiment above, the covered electric wire 12 is connected to the contact 14 by crimping the conductor portion 12A of the covered electric wire 12 to the crimp terminal portion 15, but the invention is not limited thereto, and the covered electric wire 12 can be connected by known various methods such as screw fixing, soldering, welding, and adhesion.

In addition, in the embodiment above, the covered electric wire 12 is used as a conductive connection object connected to the sheet-like conductive member 11, but an electric wire having only the conductor portion 12A whose outer periphery is not covered with the covering portion 12B made of an insulating material may also be used. Further, various conductors such as a conductor of band shape other than an electric wire can be connected to the contact 14 as a connection object.

What is claimed is:

1. A connector in which a connection object having conductivity is connected to a flexible conductor exposed at least on a bottom surface of a sheet-like conductive member having a top surface and the bottom surface facing in opposite directions from each other, the connector comprising:
a contact having conductivity, being connected to the connection object, and including a tubular portion and a top plate portion of annular shape joined to one end of the tubular portion and provided with a through hole; and
a housing including a first surface facing the top surface of the sheet-like conductive member, and a contact accommodating portion of recess shape formed in the first surface and accommodating the tubular portion of the contact,
wherein the housing includes a projection formed to project in the contact accommodating portion from a bottom surface of the contact accommodating portion and penetrating the through hole of the top plate portion joined to the tubular portion accommodated in the contact accommodating portion, and a deformed portion overhanging in a direction along the first surface from a tip of the projection in the tubular portion and covering the top plate portion around the through hole, and
wherein the top plate portion of the contact is fixed to the housing by the deformed portion of the projection in a state where the first surface of the housing makes contact with the top surface of the sheet-like conductive member and the tubular portion of the contact is accommodated in the contact accommodating portion with the sheet-like conductive member being sandwiched therebetween, and an outer peripheral surface of the tubular portion makes contact with the flexible conductor of the sheet-like conductive member in a direction parallel to the first surface, whereby the connection object is electrically connected to the flexible conductor via the contact.

2. The connector according to claim 1, wherein the contact accommodating portion of the housing has an inside diameter slightly smaller than a dimension obtained by adding a double of a thickness of the sheet-like conductive member to an outside diameter of the tubular portion of the contact.

3. The connector according to claim 1,
wherein the contact includes a flange joined to another end of the tubular portion and extending in a direction along the first surface of the housing, and
wherein the flange makes contact with the flexible conductor of the sheet-like conductive member.

4. The connector according to claim 3, comprising a crimp terminal portion joined to the flange and to be connected with the connection object.

5. The connector according to claim 1, wherein the connection object is composed of an electric wire.

6. The connector according to claim 1, wherein the housing is made of an insulating resin material.
